(19) United States
(12) Patent Application Publication
(10) Pub. No.: US 2018/0019952 A1
(43) Pub. Date: Jan. 18, 2018

(54) Method to Provide High Throughput Transport by IP Network Channel Associated Signaling System

(71) Applicant: Futurewei Technologies, Inc., Plano, TX (US)

(72) Inventors: Guoping Li, Plano, TX (US); Lin Han, San Jose, CA (US); Boyan Tu, Plano, TX (US)

(21) Appl. No.: 15/601,367

(22) Filed: May 22, 2017

Related U.S. Application Data
(60) Provisional application No. 62/362,518, filed on Jul. 14, 2016.

(51) Int. Cl. H04L 12/801; H04L 29/06

(52) U.S. Cl. CPC H04L 47/35; H04L 69/22; H04L 47/12; H04L 69/16

(57) ABSTRACT

A method of providing high throughput and low latency Internet protocol (IP) transport using channel associated signaling (CAS) comprises receiving, by a network element, a packet, wherein the packet comprises user data and parameters for controlling traffic and bandwidth for a data flow along a common path, and wherein the header of the packet comprises the parameters for controlling traffic and bandwidth for the data flow along the common path, and controlling, by the network element, traffic according to the parameters in the packet.

### CROSS-REFERENCE TO RELATED APPLICATIONS

The present application claims benefit of U.S. Provisional Patent Application No. 62/362,518 filed Jul. 14, 2016 by Lin Han, et al. and entitled “Method to Provide High Throughput Transport by IP Network Channel Associated Signaling System,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Transmission Control Protocol (TCP) is a reliable transport layer protocol of the Internet protocol (IP) suite of protocols and that provides reliability to applications, and builds on IP's unreliable datagram (packet) service. TCP underlies the vast majority, estimated to be around 90 percent (%), of all the traffic on the Internet. TCP is designed for end user applications. To establish a TCP connection, a client and a server use a “three-way handshake” to synchronize on each other's initial sequence numbers. The handshake is based on an exchange of connection-establishing segments carrying a control bit called “SYN” in their segment headers, along with the initial sequence numbers. Each side must also receive the other side's initial sequence number and send a confirming acknowledgment. To initiate the connection, the client sends a SYN packet to the server, indicating its initial sequence number (ISN). The server responds with a SYN-acknowledgement (ACK) packet, giving its own ISN and acknowledging the ISN sent by the client (by setting the ACK bit and placing the value ISN+1 in the acknowledgment number field). The client finally responds with an ACK packet, acknowledging the ISN sent by the server, and the connection is thus established.

TCP performance is typically degraded to some extent in terms of lowered throughput and link utilization by, but not limited to, the following link characteristics: long delay, high bandwidth, high error rate, link asymmetry, and link variability. For example, ultra-high throughput applications, such as videos having a horizontal resolution on the order of 4,000 pixels (4K), videos having a horizontal resolution on the order of 8,000 pixels (8K), virtual reality (VR) applications, and/or other applications that require a large data transfer cannot use TCP to transmit data without resulting in network congestion. For example, common 4K video files need a throughput of 25 megabits per second (Mbps). Sometimes, the peak bit rate for 4K video file transmission can even reach 50 Mb/s or higher. Increasing the physical link bandwidth cannot increase the TCP throughput for the application.

### SUMMARY

Typically, TCP congestion control in a network is performed by a host instead of a router. The host receives packet loss data reported by another host and calculates round trip times (RTTs) to indirectly determine a congestion window and adjust a sending rate accordingly. Therefore, the traditional mechanisms for congestion control require the host to implement a black box system of indirectly calculating congestion related data that can be better performed by the routers within the network. Embodiments of the present disclosure involve sending bandwidth related parameters to the routers in a network such that the routers independently control the network traffic according to the parameters. Embodiments of the present disclosure enable the router to ensure that the current bandwidth for a TCP flow satisfies the parameters, thus, more efficiently preventing congestion overload and ensuring a higher throughput and QoS.

In one embodiment, the disclosure includes a network element (NE) to provide high throughput IP transport using channel associated signaling (CAS), comprising a receiver configured to receive a packet, wherein the packet comprises user data and parameters for controlling traffic and bandwidth for a data flow along a common path, wherein the header of the packet comprises the parameters for controlling traffic and bandwidth for the data flow along the common path, and a processor operably coupled to the receiver and configured to control traffic according to the parameters in the packet. In some embodiments, the disclosure further includes wherein the packet comprises an indicator that identifies whether the packet comprises the parameters for controlling traffic and bandwidth, and/or wherein the parameters comprise at least one of an average bandwidth or a macro time interval, and/or wherein the parameters comprise at least one of a burst threshold or a micro time interval, and/or wherein the parameters comprise at least one of a minimum bandwidth or a maximum bandwidth, and/or wherein the packet comprises a field that indicates the values that are carried in the parameters, and/or wherein the parameters comprise at least one of an end-to-end (E2E) latency or an accumulated latency.

In one embodiment, the disclosure includes method of providing high throughput and low latency IP transport, comprising receiving, by a network element, a packet, wherein the packet comprises user data and parameters for controlling traffic and bandwidth for a data flow along a common path, wherein the header of the packet comprises the parameters for controlling traffic and bandwidth for the data flow along the common path, and controlling, by the network element, traffic according to the parameters in the packet. In some embodiments, the disclosure further includes wherein the packet is received from a source host, and/or wherein the packet is received from a second network element, and/or wherein the parameters indicate a version of TCP CAS used and a state of a session setup between a client and a server, and/or wherein the packet comprises control data and the user data, wherein the control data comprises the parameters, and wherein the control data and the user data comprise a common IP protocol number, source address, destination address, source port number, and destination port number, and/or wherein the packet uses an extension TCP, and/or wherein the packet uses an extension of User Datagram Protocol (UDP).

In one embodiment, the disclosure includes a first NE to provide high throughput IP transport, comprising a processor configured to control traffic according to parameters in a packet, wherein the packet comprises user data and parameters for controlling traffic and bandwidth for a data flow along a common path, wherein the header of the packet comprises the parameters for controlling traffic and bandwidth for the data flow along the common path, and a transmitter operably coupled to the processor and configured to transmit the packet toward a second NE according to the parameters in the packet. In some embodiments, the disclosure further includes wherein the packet comprises an indicator that identifies whether the packet comprises the parameters for controlling traffic and bandwidth, and/or wherein the parameters comprise at least one of an average bandwidth or a macro time interval, and/or wherein the parameters comprise at least one of a burst threshold or a micro time interval, and/or wherein the parameters comprise at least one of a minimum bandwidth or a maximum bandwidth, and/or wherein the parameters comprise at least one of an E2E latency or an accumulated latency.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a network configured to implement CAS.

FIG. 2 is a schematic diagram of a NE suitable for providing traffic control and bandwidth guaranteeing mechanisms disclosed herein.

FIG. 3 is a graph illustrating different parameters that are sent by NEs to facilitate implementation of the traffic control and bandwidth guaranteeing mechanisms disclosed herein.

FIG. 4 is a schematic diagram of a client attempting to start a connection to a server using CAS by sending the parameters to other NEs.

FIG. 5 is an embodiment of a portion of a CAS packet with TCP option encoding.

FIG. 6 is an embodiment of a portion of a CAS packet including one or bits defining a capability.

FIG. 7 is an embodiment of a portion of a CAS packet including one or more bits defining whether to and how to monitor congestion according to a macro time interval.

FIG. 8 is an embodiment of a portion of a CAS packet including one or more bits defining whether to monitor congestion according to a micro time interval T2.

FIG. 9 is an embodiment of a portion of a CAS packet including one or more bits defining an average bandwidth B1.

FIG. 10 is an embodiment of a portion of a CAS packet including one or more bits defining a burst threshold.

FIG. 11 is an embodiment of a portion of a CAS packet including bits to define the OAM data.

FIG. 12 is an embodiment of a portion of a CAS packet including bits to define the bandwidth data.

FIG. 13 is an embodiment of a portion of a CAS packet including bits to define latency data.

FIG. 14 is a method of signaling parameters using CAS.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Standard implementations of TCP congestion control algorithms are implemented at the host, rather than at the routers or gateways of the network. For example, in implicit congestion indication based TCP optimization acceleration methods, a host receives a packet loss amount and/or RTTs from a router or gateway, and the host uses the packet loss and/or RTT to compute a congestion window. The congestion window is maintained by a sender and is used to stop a link between the sender and the receiver from becoming overloaded with too much traffic. The congestion window is calculated by estimating how much congestion there is on a link. The congestion window keeps growing as acknowledgements (ACKs) are received by the host until a timeout occurs or the sender reaches a congestion threshold. The implicit congestion indication based TCP optimization acceleration methods that use a packet loss ratio (PLR) may be used in congestion control protocols, such as, Reno algorithms, scalable transmission control protocol (S-TCP), high speed TCP (HSTCP), Hamilton TCP (H-TCP), binary increase congestion control (BIC TCP), CUBIC, and/or other congestion control protocols that are compatible with TCP. The implicit congestion indication based TCP optimization acceleration methods that use RTT may be used in congestion protocols, such as, TCP VEGAS, Fast TCP, and/or other congestion control protocols that are compatible with TCP. The implicit congestion indication based TCP optimization acceleration methods that use both PLR and RTT may be used in congestion protocols, such as TCP VENO, Compound TCP, and/or other congestion control protocols that are compatible with TCP.

In an embodiment, a TCP optimization and acceleration technology involves the use of an explicit congestion indication. For example, a router explicitly notifies a host of the congestion such that the host adjusts the packet rate. The explicit congestion indication may be used in congestion control protocols, such as, Universal Measurement and Calibration Protocol (XCP), Variable-structure congestion Control Protocol (VCP), and/or other congestion control protocols that are compatible with TCP. However, explicit congestion indication is rarely used in TCP optimization schemes.

The problem with using these traditional congestion indication methods is that an inaccurate congestion indication is measured and reported. For example, the congestion indication does not distinguish between packet losses due to random events, long term, and short term congestion. In addition, both the implicit congestion indication method and the explicit congestion indication method have a slow reaction time because the congestion window can only be updated every RTT. Therefore, the congestion window gradually approaches bandwidth capacity after multiple RTTs. Most TCP optimization mechanisms are based on an estimate of the congestion status of the network, or a black box, and thus, cannot completely solve the problems of inaccurate congestion indication and slow reaction time. Therefore, TCP congestion control is limited in that it is difficult to maximize throughput and minimize reaction time for all scenarios, and it is difficult to make the throughput completely independent of RTT. TCP cannot guarantee bandwidth and QoS because it is difficult to directly provide QoS to TCP without the involvement of other protocols.

Disclosed herein is a method and system for IP transport based on CAS. As will be more fully explained below, in an embodiment of CAS, routers are configured to transmit control data and user data on the exact same path that passes through the same nodes and links to reach the destination. In an embodiment, control data and user data are forwarded or switched by exactly the same process. Control data may comprise the same IP protocol number, source and destination address, and source and destination port number as the user data from end to end, including the host and each intermediate NE. CAS may use the extension of TCP, UDP, or other protocols. The extension of TCP may comprise new defined TCP options fields to embed CAS parameters for QoS.

The IP transport based on CAS disclosed herein may overcome the problems of traditional TCP congestion control and other optimization technologies. In addition, the IP transport based on CAS can provide high throughput that does not have the limitations of traditional TCP. Further, different data plans may be implemented using CAS.

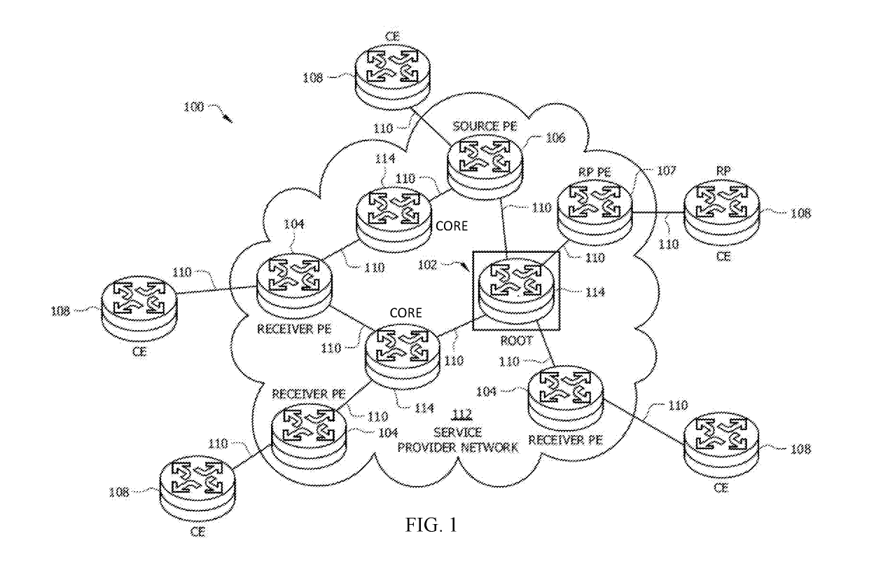

FIG. 1 illustrates an embodiment of a network 100 configured to implement CAS. The network 100 may be a TCP/IP packet-switched network in which TCP may be implemented. TCP may be implemented according to RFC 793, titled “Transmission Control Protocol,” published September 1981, which is hereby incorporated by reference in its entirety. The network 100 generally comprises a plurality of routers (e.g., label switch routers (LSRs)), for example a root router 102, one or more receiver provider edge (PE) routers 104, one or more source PE routers 106, one or more rendezvous point (RP) PE routers 107, one or more customer edge (CE) routers 108, and one or more core routers 114. Additionally, the plurality of routers (e.g., the root router 102, the receiver PE routers 104, the source PE router 106, the CE routers 108, the core routers 114, etc.) may be interconnected and in data communication with each other via one or more links 110 (e.g., a wireless link or a wired link). Further, the network 100 is configured to employ an internet group management protocol (IGMP), an intermediate system to system (IS-IS) protocol, a routing information protocol (RIP), a border gateway protocol (BGP), a distance vector multicast routing protocol (DVMRP), a multicast open shortest path first (MOSPF), and/or any suitable routing protocol as would be appreciated by one of ordinary skill in the art upon viewing this disclosure.

The plurality of routers (e.g., the root router 102, the receiver PE routers 104, the source PE routers 106, the CE routers 108, the core routers 114, etc.) may each be a device configured to forward data packets within a network and/or between multiple networks. For example, a core router 114 may be a router within a service provider network 112 and may be configured to form a portion of a backbone or core for the service provider network 112. A receiver PE router 104 and/or a source PE router 106 may be a router within the service provider network 112 which may be configured to form an interface between the service provider network 112 and one or more CE routers 108.

A source PE router 106 may be generally characterized as a PE router where a multicast source (e.g., a host) is located on or behind a CE router 108. Referring to the example embodiment of FIG. 1, the network 100 comprises the root router 102 in data communication with the receiver PE routers 104, the source PE router 106, and the core routers 114. Additionally, the PE routers (e.g., the receiver PE routers 104 and the source PE routers 106) are each in data communication with a CE router 108. Additionally, each of the routers may be configured to employ a routing table, forwarding table, network table, or the like, to control and/or direct data traffic for a given network. For example, each of the routers may generate or establish a routing table to coordinate data communication with other routers within the network 100. In an example embodiment, the routing table may be established via a flooding algorithm, a spanning trees algorithm, a reverse path broadcasting algorithm, a truncated reverse path broadcasting algorithm, a reverse path multicasting algorithm, a core-based tree algorithm, or any other suitable multicast forwarding algorithm as would be appreciated by one of ordinary skill in the art upon viewing this disclosure. Additionally, one or more routers (e.g., a root router 102, a receiver PE router 104, a source PE router 106, etc.) may be configured to implement CAS such that CAS packets may be transmitted between the routers.

Most IP control protocols use common channel signaling (CCS), in which signaling traffic (e.g., control data) and user traffic (e.g., user data) is signaled separately so that each is processed different. In one embodiment, CAS allows for user and control signaling traffic to be sent together. In an embodiment, control data takes the exact same path as the user's data flow through the network and all network devices. In CAS, the signaling packet and user's data packet are subject to the same processes in hardware, such as processing hardware, queue, scheduler, etc. CAS may be realized at the hardware level such that no control central processing unit (CPU) is involved. CAS is simpler than CCS because CCS is complicated in that CCS may only be realized by the control CPU involvement.

In an embodiment of CAS, control data and user data is transmitted together. In an embodiment, control data is attached to user data without being encoded as a special type of user data. In such an embodiment, the user data and the control data have the same parameters, such as, IP protocol number assigned by the Internet Assigned Numbers Authority (IANA), source IP address, destination IP address, source port number, and/or destination port number. Because the user data and the control data have the same parameters, the user data and the control data will take the exact same path and pass through the exact same nodes and links in the network from source to destination. In addition, the user data and the control data may be forwarded or switched by the exact same processes.

In an embodiment, a source PE router 106 transmits a data flow using CAS. The data flow comprises packets that carry basic parameters for controlling traffic and bandwidth for a data flow along a common path. The parameters carried in the data flow are sent to the next router (e.g., routers 102, 104, 107, 108, or 112) on the path such that the next router executes proper resource reservation according to the parameters carried in the data flow. In this way, all routers from a source to a destination use parameters received from a previous router or host to properly reserve resources without the risk of exceeding a bandwidth congestion limit. Routers can also use the parameters to properly pace traffic and ensure that packets are not lost due to congestion.

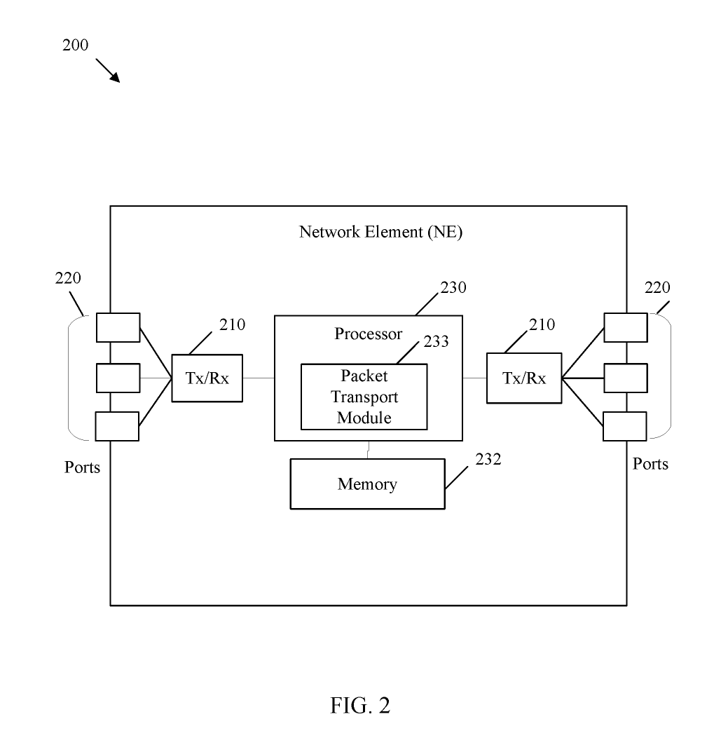

FIG. 2 is a schematic diagram of a NE 200 suitable for providing traffic control and bandwidth guaranteeing mechanisms disclosed herein. In other words, the NE 200 is configured to encapsulate and decapsulate (e.g., unencapsulate) packets as described herein. NE 200 of FIG. 2 is similar to the NEs (e.g., routers 102, 104, 106, 107, 108, or 112, etc.) of FIG. 1. In an embodiment, the NE 200 is a switch, router, gateway, or other device used in the transportation of packets or information across a network.

NE 200 comprises ports 220, transceiver units (Tx/Rx) 210, a processor 230, and a memory 232. The processor 230 comprises a packet transportation module 233. Ports 220 are coupled to Tx/Rx 210, which may be transmitters, receivers, or combinations thereof. The Tx/Rx 210 may transmit and receive data via the ports 220. Processor 230 is configured to process data. Memory 232 is configured to store data and instructions for implementing embodiments described herein. The NE 200 may also comprise electrical-to-optical (EO) components and optical-to-electrical (OE) components coupled to the ports 220 and Tx/Rx 210 for receiving and transmitting electrical signals and optical signals.

The processor 230 may be implemented by hardware and software. The processor 230 may be implemented as one or more CPU chips, logic units, cores (e.g., as a multi-core processor), field-programmable gate arrays (FPGAs), application specific integrated circuits (ASICs), and digital signal processors (DSPs). The processor 230 is in communication with the ports 220, Tx/Rx 210, and memory 240. The packet transport module 232 is implemented by processor 230 to execute the instructions for implementing various embodiments discussed herein. For example, the packet transport module 232 is configured the parameters for controlling traffic and bandwidth for a data flow along a common path. In an embodiment, the parameters are carried in optional fields in a header of the packet. In such an embodiment, the packet transport module 232 extracts the parameters from the optional fields in the header of the packet. The packet transport module 232 may program the NE 200 to control traffic according to the parameters. In an embodiment, the packet transport module 232 is configured to control traffic along the common path according to the parameters. The inclusion of the packet transport module 233 provides an improvement to the functionality of NE 200. The packet transport module 233 also effects a transformation of network element 200 to a different state. Alternatively, the packet transport module 233 is implemented as instructions stored in the memory 232.

The memory 232 comprises one or more of disks, tape drives, or solid-state drives and may be used as an over-flow data storage device, to store programs when such programs are selected for execution, and to store instructions and data that are read during program execution. The memory 232 may be volatile and non-volatile and may be read-only memory (ROM), random-access memory (RAM), ternary content-addressable memory (TCAM), and static random-access memory (SRAM).

It is understood that by programming and/or loading executable instructions onto the NE 200, at least one of the processor 230 and/or memory 232 are changed, transforming the NE 200 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

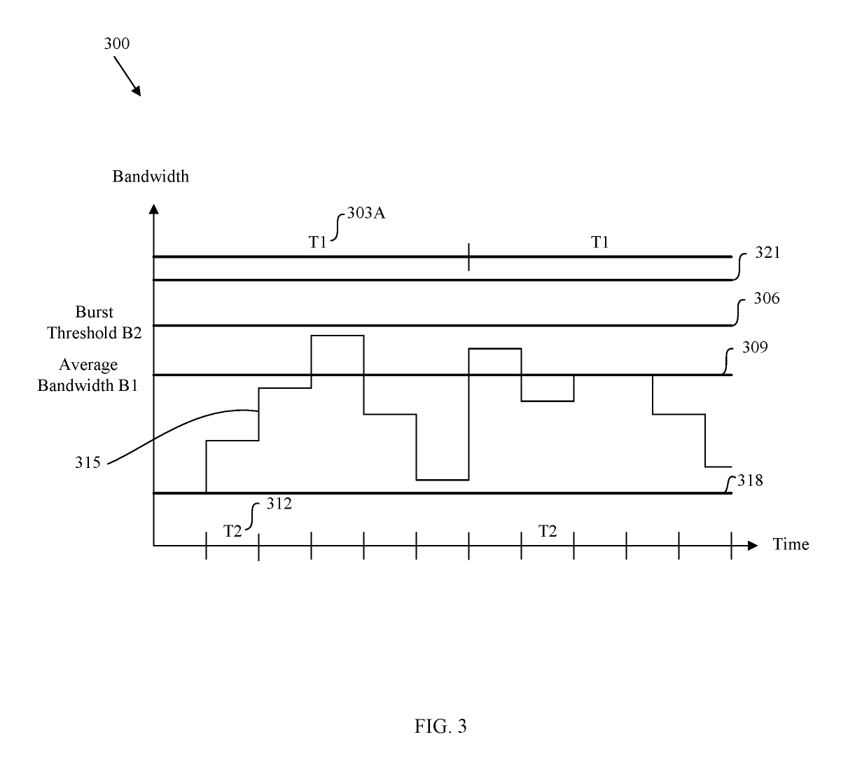

FIG. 3 is a graph 300 illustrating different parameters that are sent by NEs to facilitate implementation of the traffic control and bandwidth guaranteeing mechanisms. FIG. 3 graphically represents examples of parameters that can be sent by a first NE (e.g., NE 200) to a second NE along a path for a data flow using CAS. As should be appreciated, other control parameters may be sent by the NE besides those shown in graph 300. As shown in FIG. 3, T1 303 represents a first time interval or macro time scale. B1 309 represents an average bandwidth. At the end of each T1 303, an NE determines whether the actual bandwidth 315 (i.e., total number of packets on a link or the rate of packets being transmitted on a link) on a link is less than the average bandwidth B1 309. In an embodiment, the NE may only send a packet or a data flow along the link if the actual bandwidth 315 is less than the average bandwidth B1 309. As shown in FIG. 3, T2 312 represents a second time interval or a micro time scale, and B2 306 represents a burst threshold. At the end of each T2 312, an NE determines whether the actual bandwidth 315 required to transmit a burst of packets or during pacing exceeds the burst threshold B2 306. In an embodiment, the total number of packets transmitted during a burst cannot exceed the burst threshold B2 306. In an embodiment, T2 312 is a subset of T1 303, and T1 303 may be an integer multiple of T2 312. In this way, bandwidth is guaranteed on at least one link between a source and destination because CAS is used to signal to each NE on a path to reserve a specified amount of bandwidth at various time intervals while also taking into account packet bursts. Although FIG. 3 shows that the burst threshold B2 306 is greater than the average bandwidth B1 309, it should be appreciated that in some configurations, the burst threshold B2 306 can be predefined to be less than the average bandwidth B1 309.

As shown in FIG. 3, the parameters may also include a minimum bandwidth 318 and a maximum bandwidth 321. The minimum bandwidth 318 may be the minimum bandwidth that must be available for a TCP flow to be transmitted. The maximum bandwidth 321 may be the maximum bandwidth that can be consumed by the TCP flow between two NEs. In an embodiment, an NE may not transmit a data flow along a link if the current bandwidth, or customer traffic rate, on the link is below the minimum bandwidth. In an embodiment, a current bandwidth should be between the minimum bandwidth and the maximum bandwidth while the link bandwidth (physical resource) must be greater than the maximum bandwidth. In some embodiments, the parameters may also include End-to-End latency (E2E latency) and/or accumulated latency. E2E latency is an expected latency from host-to-host by which an accumulated latency of a plurality of NEs on a common path may not exceed and is predefined by a source of a TCP connection. For example, each NE on a common path from a source to destination adds a current latency to the accumulated latency value and compares the accumulated latency to E2E latency to ensure that the accumulated latency does not exceed the E2E latency. The accumulated latency is the promised latency for each of the routers on a path.

In one embodiment, CAS may include transmission of traffic control and/or parameters macro time scale T1 303, micro time scale T2 312, average bandwidth B1 309, burst threshold B2 306, minimum bandwidth 318, and/or maximum bandwidth 321. Each of the parameters may have different units. CAS may trigger proper resource reservation at all NEs from the source to the destination for each of the parameters. For example, each of the nodes may store a lookup table for resources that need to be reserved for certain parameters. Parameters macro time scale T1 303, micro time scale T2 312, average bandwidth B1 309, burst threshold B2 306, minimum bandwidth 318, and/or maximum bandwidth 321 are used by a CAS QoS mechanism to obtain the QoS. The CAS QoS mechanism may be executed at a host and/or at each NE on the path from the source to the destination. An application can obtain the guaranteed bandwidth and implement proper traffic pacing to avoid burstiness in network traffic and thus reduce the probability of packet loss after the QoS mechanism is executed. The parameters may be given by an application directly and may be configurable by the application and/or a host.

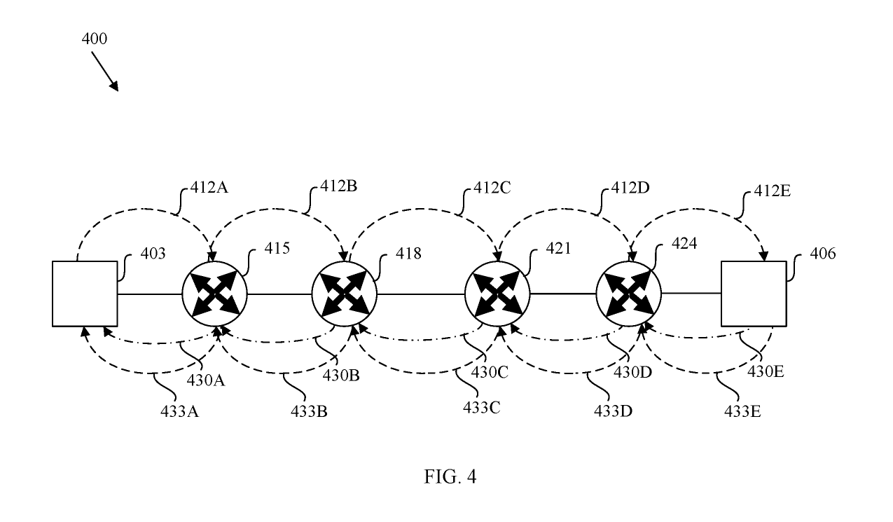

FIG. 4 is a schematic diagram 400 of a client 403 attempting to start a connection to a server 406 using CAS by sending the parameters to other NEs. Diagram 400 illustrates CAS signaling for a QoS path with the same return direction. The client 400 may request a connection by sending a setup request message 412A-E including signaling parameters, such as the parameters discussed with reference to FIG. 3. In an embodiment, the setup request messages 412A-E instruct the NEs 415, 418, 421, and 424 to be programmed to transmit a data flow along the common path in the downstream and/or upstream according to the parameters in the setup request message 412A-E. The setup request message 412A-E is forwarded along the NEs 415, 418, 421, and 424 of the path until the setup request message 412A-E is received by the server 406.

In an embodiment, the client 403 sends the setup request message 412A to the NE 415. The setup request messages 412A-E may include the parameters for controlling traffic and bandwidth for a data flow along a common path. For example, the parameters include a macro time scale T1, micro time scale T2, average bandwidth B1, burst threshold B2, maximum bandwidth, and/or minimum bandwidth (e.g., macro time scale T1 303, micro time scale T2 312, average bandwidth B1 309, burst threshold B2 306, minimum bandwidth 318, and/or maximum bandwidth 321). In an embodiment, the setup request message 412A may include parameters such as E2E latency, accumulated latency, and/or any other bandwidth related information to help ensure a specified QoS. The setup request message 412A may include other parameters related to bandwidth reservation and initiating a TCP connection between the client 403 and the server 406. The setup request message 412A may also include other parameters related to bandwidth reservation and initiating a TCP connection between the client 403 and the server 406, such as operations, administration and maintenance (OAM) data. The parameters in the setup request message 412A and the parameters in the setup request message 412B may be the same as each other or different from each other. In an embodiment, the setup response message 412A-E may include parameters for programming NEs 415, 418, 421, and 424 in the downstream direction only. In an embodiment, the setup response messages 412A-E include the parameters in optional fields of a header of the setup response messages 412A-E, as is be further described below.

The server 406 may respond with a setup response message 430A-E, which is forwarded in the return direction of the path along NEs 424, 421, 418, and 415. In an embodiment, the setup response messages 430A-E instruct the NEs 415, 418, 421, and 424 to be programmed to transmit a data flow along the common path in the downstream and/or upstream according to the parameters in the setup response message 430A-E. The parameters in the setup request message 412A-E and the parameters in the setup response message 430A-E may be the same as each other or different from each other. The setup response message 430A-E may also include parameters for controlling traffic and bandwidth for the data flow along the common path. The setup response messages 430A-E may include the parameters for controlling traffic and bandwidth for a data flow along a common path. For example, the parameters include a macro time scale T1, micro time scale T2, average bandwidth B1, burst threshold B2, maximum bandwidth, and/or minimum bandwidth (e.g., macro time scale T1 303, micro time scale T2 312, average bandwidth B1 309, burst threshold B2 306, minimum bandwidth 318, and/or maximum bandwidth 321). In an embodiment, the setup response message 430A may include parameters such as E2E latency, accumulated latency, and/or any other bandwidth related information to help ensure a specified QoS. The setup response message 430A may include other parameters related to bandwidth reservation and initiating a TCP connection between the server 406 and the client 403. The setup response message 430A may also include other parameters related to bandwidth reservation and initiating a TCP connection between the client 403 and the server 406, such as OAM data. The parameters in the setup response message 430A and the parameters in the setup response message 430B may be the same as each other or different from each other. In an embodiment, the setup response message 430A-E may include parameters for programming NEs 415, 418, 421, and 424 in the upstream direction only. In an embodiment, the setup response messages 430A-E include the parameters in optional fields of a header of the setup response messages 430A-E, as is be further described below.

In an embodiment, each of the setup response messages 430A-E may also indicate whether NEs 415, 418, 421, and 424 have been successfully programmed according to the parameters in each of the setup request messages 412A-E. For example, NE 424 includes the parameters in the header of setup response message 430D and an acknowledgement as to whether NE 424 has been successfully programmed to transmit a data flow according to the parameters in setup request message 412D. Similarly, NE 421 may also include the parameters in the header of setup response message 430C and an acknowledgement as to whether NE 421 has been successfully programmed to transmit the data flow according to the parameters in setup request message 412C.

The client acknowledges the response by sending the setup acknowledgement message 433A-E. In an embodiment, the setup acknowledgement messages 433A-E further instruct the NEs 415, 418, 421, and 424 to be programmed to transmit a data flow along the common path in the downstream and/or upstream according to the parameters in the setup acknowledgement messages 433A-E. In an embodiment, the parameters in the setup acknowledgement messages 433A-E may be the same as the parameters in the setup request message 412A-E. For example, the parameters in the setup acknowledgement messages 433A-E may set new parameters by which NEs 415, 418, 421, and 424 are to be programmed. In an embodiment, the parameters in the setup acknowledgement messages 433A-E may be different from the parameters in the setup request messages 412A-E. For example, the parameters in the setup acknowledgment messages 433A-E may add new parameters that were not included in setup request messages 412A-E.

For example, the parameters include a macro time scale T1, micro time scale T2, average bandwidth B1, burst threshold B2, maximum bandwidth, and/or minimum bandwidth (e.g., macro time scale T1 303, micro time scale T2 312, average bandwidth B1 309, burst threshold B2 306, minimum bandwidth 318, and/or maximum bandwidth 321). In an embodiment, the setup acknowledgement message 433A may include parameters such as E2E latency, accumulated latency, and/or any other bandwidth related information to help ensure a specified QoS. The setup acknowledgement message 433A may include other parameters related to bandwidth reservation and initiating a TCP connection between the server 406 and the client 403. The setup acknowledgement message 433A may also include other parameters related to bandwidth reservation and initiating a TCP connection between the client 403 and the server 406, such as OAM data. In an embodiment, each of the NEs 415, 418, 421, and 424 may add different OAM data to the setup acknowledgement messages 433A-E regarding a programming status of each of the NEs 415, 418, 421, and 424. The parameters in the setup acknowledgement message 433A and the parameters in the setup acknowledgement message 433B may be the same as each other or different from each other. In an embodiment, the setup acknowledgement message 433EA-E may include parameters for programming NEs 415, 418, 421, and 424 in the upstream downstream only. In an embodiment, the setup acknowledgement messages 433A-E include the parameters in optional fields of a header of the setup acknowledgement messages 433A-E, as is be further described below. In an embodiment, the setup acknowledgment messages 433A-E may also include an acknowledgment as to whether NEs 415, 418, 421, and 424 have been properly programmed in the opposite direction according to setup response messages 430A-E.

CAS may be designed in a different ways. In one embodiment, CAS may be embodied as TCP with an extension configured to implement the CAS embodiments disclosed herein. For example, CAS may be implemented as a TCP packet with additional optional fields. In one embodiment, CAS may be embodied as a UDP with an extension configured to implement the CAS embodiments disclosed herein. For example, CAS may be implemented as a UDP packet with additional optional fields. In one embodiment, CAS may be generated as a new transport protocol configured to implement the CAS embodiments disclosed herein.

As an illustrative example, the client 403 may attempt to start a TCP connection according traffic control and bandwidth guarantee mechanisms using CAS signaling as an extension of TCP. Referring to FIG. 4, the client 403 may request a connection by sending a synchronize message (TCP SYN) (e.g., setup request message 412A-E) to the server 406. For example, the synchronize message includes several different parameters, such as M, N, and OP. Parameter M is the average bandwidth in a given time and may be denoted by M downstream (d) and/or M upstream (u). Parameter N is a burst number in a given time and may have Nd and/or Nu. Parameter OP represents other parameters such as a state, OAM data, and data plane required parameters. The synchronize message is passed through the NEs 415, 418, 421, and 424 on the path until the synchronize message is successfully received by the server 406. The server 406 acknowledges the synchronize request by sending a first acknowledge message (SYN-ACK) (e.g., setup response message 430A-E) back to the client. The first acknowledge message also includes parameters M, N, and OP, which may be the same or different from the parameters in the TCP SYN message. The first acknowledge message is also passed through the NEs 424, 421, 418, and 415 until the acknowledge message is successfully received by the client. The client responds with a second acknowledgement message (ACK) (e.g., acknowledgement message 433A-E). The second acknowledgement message includes the parameter St, which indicates whether the connection has been established such that the client 403, server 406, and/or the NEs 415, 418, 421, and 424 on the path are configured to monitor traffic and implement the traffic control and bandwidth guarantee mechanism according to parameters of the CAS messages exchanged. In one embodiment, all CAS parameters are encoded as new TCP options.

In one embodiment, packets transmitted using CAS includes a CAS indicator. The CAS indicator is a flag that indicates that the packet has CAS embedded. In one embodiment, the CAS indicator is used to immediately signal to the hardware process that the packet has CAS data. In this way, the hardware can efficiently process the packet without having to parse through the entire packet.

In one embodiment, the CAS indicator may be signaled using bit 0 in the flags section of an IP header, such as an IP version 4 (IPv4) header, of the IP packet. The IPv4 header packet is described in Internet Engineering Task Force (IEFT) draft, Request for Comments (RFC) 791, entitled “Internet Protocol,” by Information Sciences Institute at University of Southern California, published on September 1981, which is hereby incorporated by reference in its entirety. In one embodiment, the CAS indicator may be signaled using unused Differentiated Services Code Point (DSCP) Type of Service (TOS) bits in the IP header, such as an IPv4 header, of the IP packet. In one embodiment, the CAS indicator may be signaled using unused Traffic Class bits in an IP header, such as an IP version 6 (IPv6) header, of the IP packet. The IPv6 header is described in ITEF draft, RFC 2460, entitled “Internet Protocol, Version 6 (IPv6),” by S. Deering, which is hereby incorporated by reference in its entirety. In one embodiment, the CAS indicator may be signaled using a special “Flow Label” in an IP header, such as the IPv6 header, of the IP packet. In one embodiment, the CAS indicator may be signaled using at least 3 bits that are reserved following a “Data Offset” in a packet header, such as a TCP header. The TCP header is described in ITEF draft, RFC 793, entitled “Transmission Control Protocol,” by Information Sciences Institute at University of Southern California, published on September 1981, which is incorporated by reference in its entirety.

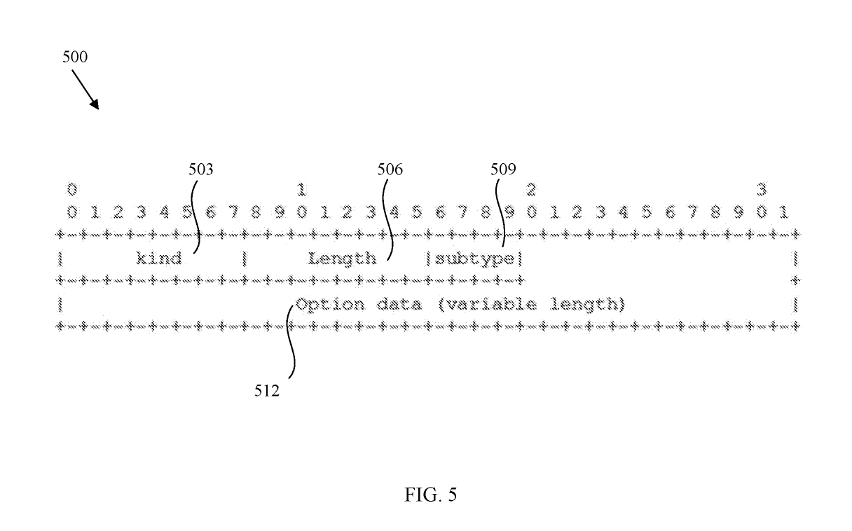

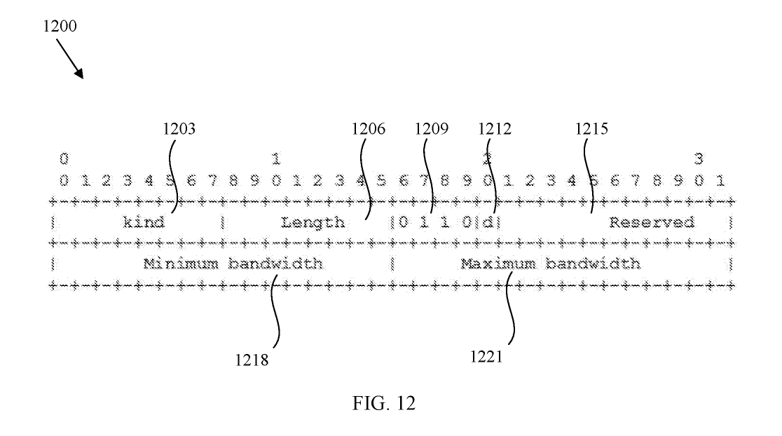

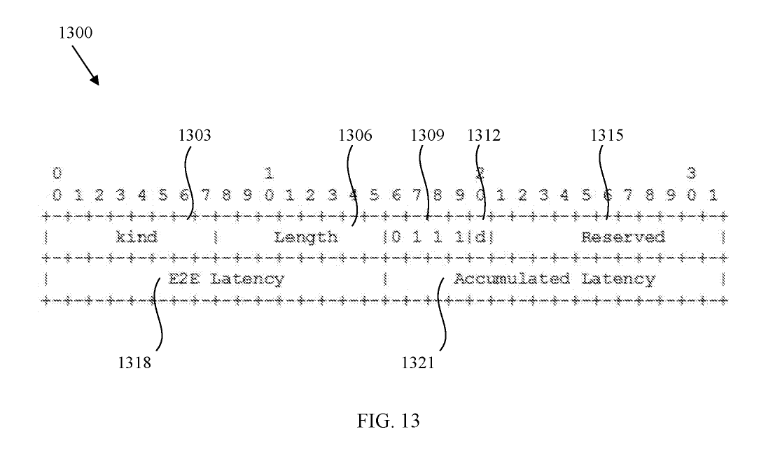

FIGS. 5-13 show various different embodiments on how to carry the parameters (e.g., macro time scale T1 303, micro time scale T2 312, average bandwidth B1 309, burst threshold B2 306, minimum bandwidth 318, maximum bandwidth 321, E2E latency, and/or accumulated latency) in a header of a TCP packet that implements CAS (CAS packet). In an embodiment, a host, such as the client 403, sends a CAS packet to each NE on a path of a data flow to use macro time scale T1, micro time scale T2, average bandwidth B1, and/or burst threshold B2 as parameters when they are defined in the CAS packet, such as the CAS packets shown in FIGS. 5-11. In an embodiment, the host sends the CAS packet (data or control packet) to each NE on the path to use a required minimum bandwidth, maximum bandwidth, E2E latency, and/or accumulated latency when they are defined in a CAS packet, such as the CAS packets shown in FIGS. 12-13.

In an embodiment, the CAS packet is a packet in which the parameters defined herein are included in optional fields of a header of the packet. CAS packets may be control packets or data packets. In an embodiment, the CAS packet is sent to setup a connection session. For example, the CAS packets may be similar to the setup request messages 412A-E, setup response messages 430A-E, or the setup acknowledgement messages 433A-E. In another embodiment, the CAS packet may be a data packet in which a header of the data packet includes the parameters for controlling traffic and bandwidth for a data flow along a common path. For example, the CAS packets may be TCP data packets in which the header includes the parameters. In an embodiment, when a CAS packet is a data packet, the parameters found in the headers of the packet may be used by NEs (e.g., NEs 415, 418, 421, and 424) on the common path to refresh the connection session. For example, suppose the client 403 has already established a TCP connection with session 406 by sending and receiving the messages 412A-3, 430A-E, and 433A-E. In this case, the NEs 415, 418, 421, and 424 on the path may be successfully programmed to control traffic and bandwidth for a data flow according to the parameters found in messages 412A-3, 430A-E, and 433A-E. Subsequent to having established the connection session between client 403 and server 406, data packets may be sent upstream and downstream between client 403 and server. These data packets may also be CAS packets that include the parameters for controlling traffic and bandwidth. When one of the NEs 415, 418, 421, and 424 receives a data packet (or CAS packet) that includes the parameters in the header of the data packet, the NEs 415, 418, 421, and 424 may be configured to refresh the connection to determine whether the NEs 415, 418, 421, and 424 need to be reprogrammed according to the new parameters found in the data packet. In such a case, the NEs 415, 418, 421, and 424 are configured to be programmed according to the new parameters in the data packet.

FIG. 5 is an embodiment of a portion of a CAS packet 500 with TCP option encoding. In an embodiment, a CAS packet is a TCP packet in which TCP options (or optional fields) in the header of the TCP packet are used to carry the signaling information for routers on a path. In an embodiment, the portion of the CAS packet 500 shown in FIG. 5 is a portion of a TCP packet header that includes several optional fields, including, but not limited to, a kind field 503, a length field 506, a subtype field 509, and an option data field 512.

The kind field 503 may include a variable assigned by the IANA indicating that the packet is a CAS packet with TCP option encoding. An NE (e.g., NE 200, 415, 418, 421, or 424) that receives the CAS packet uses the value in the kind field 503 to identify whether the CAS packet 500 comprises parameters for controlling traffic and bandwidth for a data flow along a common path. The length field 506 may include the total option size in bytes of the packet including the kind field 503 and the length field 506. The subtype field 509 may indicate the subtype of the CAS. A subtype is the type within a same “kind” for a TCP option. As the kind field 503 includes a variable that indicates that the packet is a CAS packet with TCP option encoding, the different subtypes indicate different types of signaling information that may be carried in the CAS packet 500. The subtype field may also include, but is not limited to, a bit that indicates a certain capability, a macro time interval T1, a micro time interval T2, an average bandwidth B1, a burst threshold B2, and/or OAM data. The macro time interval T1 may be similar to the T1 303. The macro time interval T1 may be a time interval during which the NE determines whether the total packet number (or total packet rate) is less than or equal to the given average bandwidth B1. The micro time interval T2 may be similar to the T2 312. The micro time interval T2 may be a time interval during which the NE determines whether the total packet number, for example, during a packet burst, is less than or equal to the given burst threshold B2.

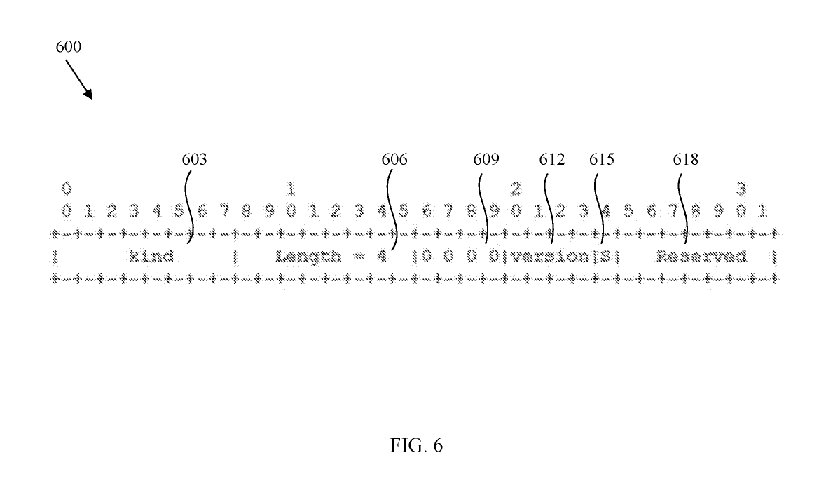

FIG. 6 is an embodiment of a portion of a CAS packet 600 including one or bits defining a capability of whether the host supports a feature, such as CAS signaling. In an embodiment, the portion of the CAS packet 600 shown in FIG. 6 is a header of the CAS packet 600 that includes several optional fields in a TCP packet, including, but not limited to, a kind field, a length field, a subtype field, a version field 612, a state of the session setup field 615, and reserved field 618.

In the CAS packet 600, there are 12 bits for optional data defining a capability of whether the host supports a feature, such as CAS signaling. One or more of these bits may indicate the version of the TCP CAS, a state of the session setup, and/or reserved bits. The kind field 603 is similar to the kind field 503, and the length field 606 is similar to the length field 506. As shown in FIG. 6, the length field 503 indicates a length of 4 bytes available to carry data defining the capability and associated data. The subtype field 609 is similar to the subtype field 509. The subtype field in CAS packet 600 includes the value 0000, indicating that the CAS packet 600 includes a capability. In an embodiment, the subtype field includes a value that indicates the parameters that are carried in the CAS packet 600. The version field 612 indicates a version number of the TCP CAS. For example, the version number indicates the different versions of CAS signaling or the information defined in the CAS option fields. The state of the session setup field 615 indicates whether the TCP session between the client (e.g., client 403) and server (e.g., server 406) has been set up. The reserved field 618 is the traditional reserved bits in a TCP packet.

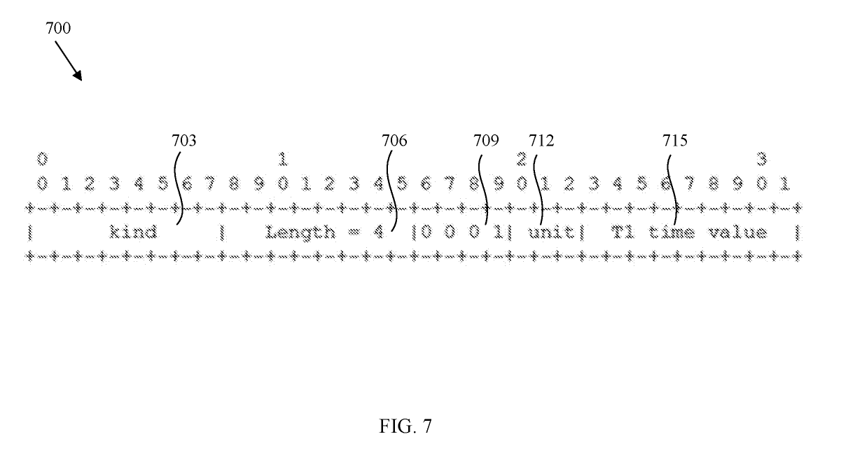

FIG. 7 is an embodiment of a portion of a CAS packet 700 including one or more bits defining whether to and how to monitor congestion according to a macro time interval (T1) (e.g., T1 303). In an embodiment, the portion of the CAS packet 700 shown in FIG. 7 is a header of the CAS packet 700 that includes several optional fields for a TCP packet, including, but not limited to, a kind field 703, a length field 706, a subtype field 709, a unit field 712, and a T1 time value field 715.

The kind field 703 may be similar to the kind field 503 and 603. The length field 706 may be similar to the length field 506 and 606. As shown in FIG. 7, the length field 706 indicates a length of 4 bytes available to carry an indication of T1 and associated data. The subtype field 709 may be similar to the subtype field 509 and 609. As shown in FIG. 7, the subtype field 709 includes the value 0001, indicating that the macro time interval T1 should be used by the receiving NE (e.g., NE 200) to monitor link congestion and that the T1 time value field 715 includes the value of the macro time interval T1. The macro time interval T1 may be a time interval during which the NE determines whether the total number of packets (or packet rate) transmitted over a link is less than and/or equal to a given pre-determined bandwidth. For example, the pre-determined bandwidth may be an average bandwidth B1 (e.g., B1 309). The unit field 712 may represent the unit of the value in the T1 time value field 715, since the number of bits available in the T1 time value field 715 is limited. The units may be represented as follows: 0: s; 1: 10⁻³ s; 2: 10⁻⁶ s; 3: 10⁻⁹ s; 4: 10⁻¹² s; 5: 10⁻¹⁵ s. The T1 time value field 715 includes the value of the macro time interval T1 that the NE obtains and then determines, at the end of every macro time interval T1, whether the total number of packets transmitted over a link is less than and/or equal an average bandwidth.

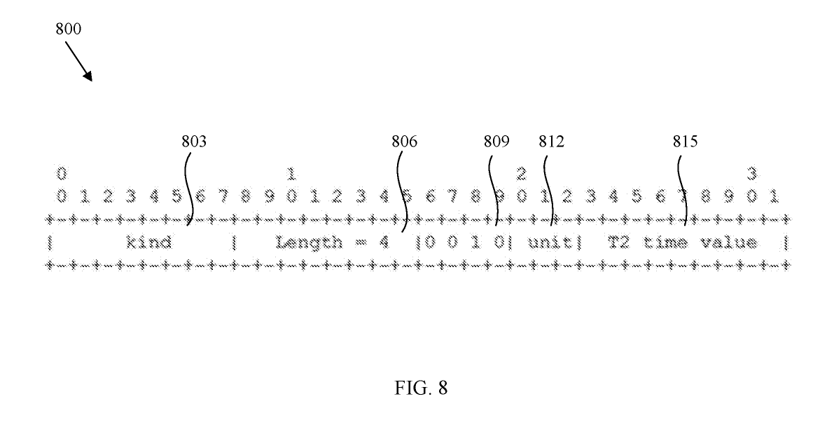

FIG. 8 is an embodiment of a portion of a CAS packet 800 including one or more bits defining whether to monitor congestion according to a micro time interval T2 (e.g., T2 312). In an embodiment, the portion of the CAS packet 800 is a header of the CAS packet 800 that includes several optional fields for a TCP packet, including, but not limited to, a kind field 803, a length field 806, a subtype field 809, a unit field 812, and a T2 time value field 815.

The kind field 803 may be similar to the kind field 503, 603, and 703. The length field 806 may be similar to the length field 506, 606, and 706. As shown in FIG. 8, the length field 806 indicates a length of 4 bytes available to carry an indication of the micro time interval T2 and associated data. The subtype field 809 may be similar to the subtype field 509, 609, and 709. As shown in FIG. 8, the subtype field 809 includes the value 0010, indicating that the macro time interval T2 should be used by the receiving NE (e.g., NE 200, 415, 418, 421, or 424) to monitor link congestion and that the T2 time value field 715 includes the value of micro time interval T2. The micro time interval T2 may be a time interval during which the NE determines whether the total number of packets (or packet rate) in a packet burst during T2 is less than and/or equal to a given pre-determined bandwidth. For example, the pre-determined bandwidth may be a burst threshold B2 (e.g., B2 306). The unit field 812 may be similar to the unit field 712. The unit field 812 may represent the unit of the value in the T2 time value field 815, since the number of bits available in the T2 time value field 815 is limited. The units may be represented as follows: 0: s; 1: 10⁻³ s; 2: 10⁻⁶ s; 3: 10⁻⁹ s; 4: 10⁻¹² s; 5: 10⁻¹⁵ s. The T2 time value field 815 includes the value of the micro time interval T2 that the NE obtains and then determines, at the end of every micro time interval T2, whether the total number of packets (or packet rate) in a packet burst is less than and/or equal to a burst threshold.

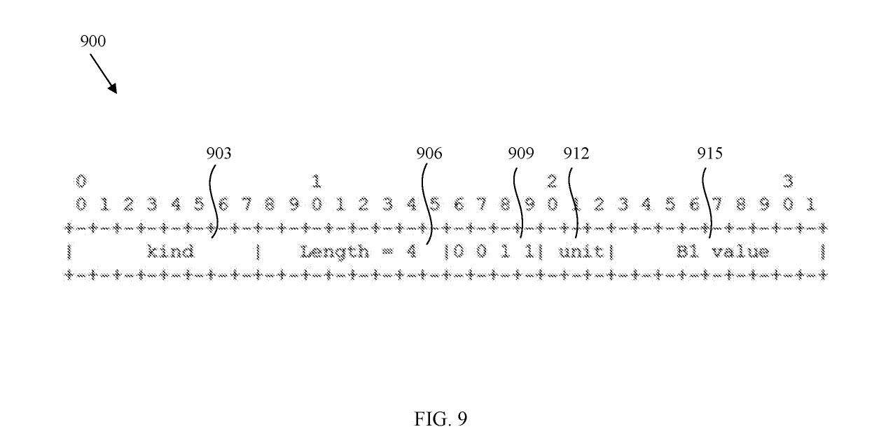

FIG. 9 is an embodiment of a portion of a CAS packet 900 including one or more bits defining an average bandwidth B1 (e.g., B1 309). In an embodiment, the portion of the CAS packet 900 includes several optional fields for a TCP packet, including, but not limited to, a kind field 903, a length field 906, a subtype field 909, a unit field 912, and a B1 value field 915.

The kind field 903 may be similar to the kind field 503, 603, 703, and 803. The length field 906 may be similar to the length field 506, 606, 706, and 806. As shown in FIG. 9, the length field 906 indicates a length of 4 bytes available to carry an indication of the average bandwidth B1 and associated data. The subtype field 909 may be similar to the subtype field 509, 609, 709, and 809. As shown in FIG. 9, the subtype field 909 includes the value 0011, indicating that the average bandwidth B1 should be used by the receiving NE (e.g., NE 200, 415, 418, 421, or 424) to monitor link congestion such that during a predefined time interval, the link congestion should not exceed the average bandwidth B1. The subtype field 909 may also indicate that the B1 value field 915 includes the value of B1. The macro time interval T1 (e.g., T1 303) may be a time interval during which the NE determines whether the total number of packets (or packet rate) being transmitted over a link during the macro time interval T1 is less than and/or equal to the average bandwidth B1. The unit field 912 may be similar to the unit field 712 and 812. The unit field 912 may represent the unit of the value in the B1 value field 915, since the number of bits available in the B1 value field 915 is limited. The units may be represented as follows: 0: 64 bytes; 1: 0.5 kilobytes (kB); 2: 1 kB; 3: 1.5 kB; 4: 2 kB; 5: 4 kB. In an embodiment, the B1 value field 915 includes the value of the average bandwidth B1 such that the NE determines, at the end of every macro time interval T1, whether a current total number of packets (or packet rate) on a link is less than and/or equal to an average bandwidth.

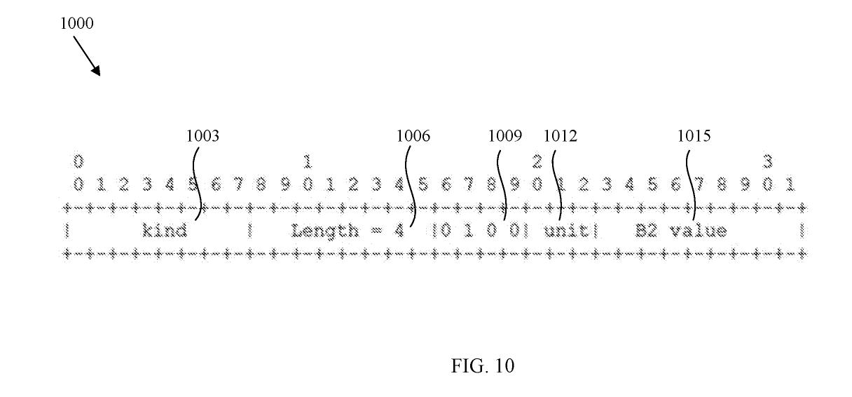

FIG. 10 is an embodiment of a portion of a CAS packet 1000 including one or more bits defining a burst threshold (B2) (e.g., B2 306). In an embodiment, the portion of the CAS packet 1000 is a header of the CAS packet 1000 that includes several optional fields for a TCP packet, including, but not limited to, a kind field 1003, a length field 1006, a subtype field 1009, a unit field 1012, and a B2 value field 1015.

The kind field 1003 may be similar to the kind field 503, 603, 703, 803, and 903. The length field 1006 may be similar to the length field 506, 606, 706, 806, and 906. As shown in FIG. 10, the length field 906 indicates a length of 4 bytes available to carry an indication of the burst threshold B2 and associated data. The subtype field 909 may be similar to the subtype field 509, 609, 709, and 809. As shown in FIG. 10, the subtype field 1006 includes the value 0100, indicating that the burst threshold B2 should be used by the receiving NE (e.g., NE 200, 415, 418, 421, or 424) to monitor link congestion such that during a predefined time interval, the link congestion for a packet burst should not exceed the burst threshold B2. The subtype field 1006 may also indicate that the B2 value field 1015 includes the value of the burst threshold B2. The micro time interval T2 (e.g., T2 312) may be a time interval during which the NE determines whether the total number of packets (or packet rate) in a packet burst during the micro time interval T2 is less than and/or equal to the burst threshold B2. The unit field 1012 may be similar to the unit field 712, 812, and 912. The unit field 1012 may represent the unit of the value in the B2 value field 1015, since the number of bits available in the B2 value field 1015 is limited. The units may be represented as follows: 0: 1 byte; 1: 2 bytes; 2: 4 bytes; 3: 10 bytes 4: 100 bytes; 4: 1 kB; 5: 2 kB. In an embodiment, the B2 value field 1015 includes the value of the burst threshold B2 such that the NE determines, at the end of every micro time interval T2, whether a packet burst that is being transmitted over a link is less than and/or equal to a burst threshold.

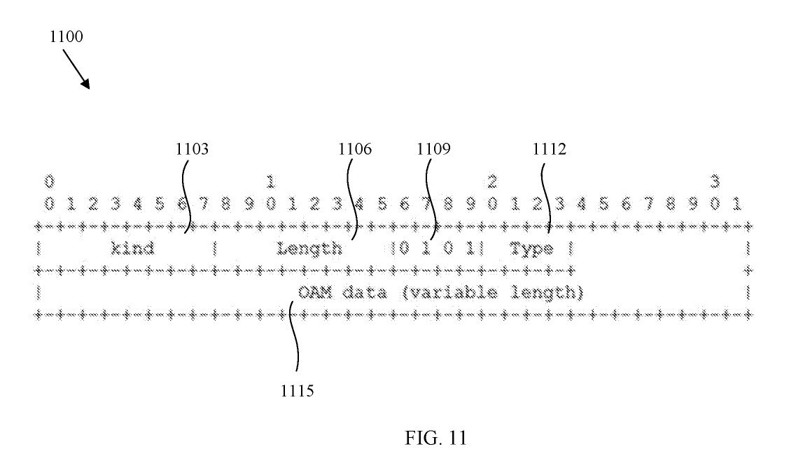

FIG. 11 is an embodiment of a portion of a CAS packet 1100 including bits to define the OAM data. In an embodiment, the portion of the CAS packet 1100 is a header of the CAS packet 1100 that includes several optional fields for a TCP packet, including, but not limited to, a kind field 1103, a length field 1106, a subtype field 1109, a type field 1112, and an OAM field 1115.

The kind field 1103 may be similar to the kind field 503, 603, 703, 803, 903, and 1003. The length field 1106 may be similar to the length field 506, 606, 706, 806, 906, and 1006. As shown in FIG. 11, the length field 1106 indicates a length of bytes available to carry OAM data, which may be a variable size. The subtype field 1109 may be similar to the subtype field 509, 609, 709, and 809. As shown in FIG. 11, the subtype field 1106 includes the value 0101, indicating that the OAM data is included in the OAM field 1115. The type field 1112 indicates an OAM type because different OAM types can be defined for different purposes. For example, OAM types can be used for various operations and management purposes, such as debugging, management, and monitoring, for the purpose of providing an enhanced QoS to customers.

FIG. 12 is an embodiment of a portion of a CAS packet 1200 including bits to define the bandwidth data. In an embodiment, the portion of the CAS packet 1200 is a header of the CAS packet 1200 that includes several optional fields for a TCP packet, including, but not limited to, a kind field 1203, a length field 1206, a subtype field 1209, a direction field 1212, a reserved field 1215, a minimum bandwidth field 1218, and a maximum bandwidth field 1221.

The kind field 1203 may be similar to the kind field 503, 603, 703, 803, 903, 1003, and 1103. The length field 1206 may be similar to the length field 506, 606, 706, 806, 906, 1006, and 1106. As shown in FIG. 12, the length field 1206 indicates a length of bytes available to carry bandwidth data, which may be a variable size. The subtype field 1209 may be similar to the subtype field 509, 609, 709, 809, 909, 1009, and 1109. As shown in FIG. 12, the subtype field 1106 includes the value 0110, indicating that CAS packet 1200 includes bandwidth data in the minimum bandwidth field 1218 and the maximum bandwidth field 1221. The direction field 1212 includes a value indicating whether the direction for the required bandwidth is upstream (from client to server) or downstream (from server to client). The reserved field 1215 is similar to the reserved field 618. The minimum bandwidth field 1218 includes a value indicating a minimum bandwidth required for a data flow. The unit for the value of the minimum bandwidth may be in Mbps. The maximum bandwidth field 1221 includes a value indicating a maximum bandwidth required for a data flow. The unit for the value of the maximum bandwidth may also be in Mbps. In an embodiment, an NE (e.g., NE 200, 415, 418, 421, 424) that receives CAS packet 1200 controls the transmission of the data flow to the next NE on a path according to the maximum bandwidth and/or the minimum bandwidth. For example, the NE that receives the CAS packet 1200 may only be configured to transmit a data flow when a bandwidth on a link to the next hope is above the minimum bandwidth but below a maximum bandwidth.

FIG. 13 is an embodiment of a portion of a CAS packet 1300 including bits to define latency data. In an embodiment, the portion of the CAS packet 1300 is a header of the CAS packet 1300 that includes several optional fields for a TCP packet, including, but not limited to, a kind field 1303, a length field 136, a subtype field 1309, a direction field 1312, a reserved field 1315, an E2E latency field 1318, and an accumulated latency field 1221.

The kind field 1203 may be similar to the kind field 503, 603, 703, 803, 903, 1003, 1103, and 1203. The length field 1306 may be similar to the length field 506, 606, 706, 806, 906, 1006, 1106, and 1206. As shown in FIG. 13, the length field 1206 indicates a length of bytes available to carry latency, which may be a variable size. The subtype field 1309 may be similar to the subtype field 509, 609, 709, 809, 909, 1009, 1109, and 1209. As shown in FIG. 13, the subtype field 1206 includes the value 0111, indicating that CAS packet 1300 includes a value for E2E latency in the E2E latency field 1318, and a value for the accumulated latency in the accumulated latency field 1321. The direction field 1312 is similar to the direction field 1212, except that the value in the direction field 1312 includes a direction for the require E2E latency. The reserved field 1315 is similar to the reserved field 618 and 1215. The E2E latency field 1318 includes a value for an E2E latency for a TCP connection. The accumulated latency field 1321 includes a value for the accumulated latency from a TCP source to a destination such that each NE (e.g., NE 200, 415, 418, 421, 424) receiving the CAS packet 300 determines whether the accumulated latency exceeds the E2E latency. The unit for the value in the E2E latency field 1318 may be milliseconds (ms).

E2E latency is an expected latency from host-to-host by which an accumulated latency of a plurality of NEs on a common path may not exceed and is predefined by a source of a TCP connection. The accumulated latency is the promised latency for each of the routers on a path. In an embodiment, an NE that receives the CAS packet 1300 adds a current latency to the accumulated latency and continues to pass the CAS packet 1300 to the next hop on the path. The TCP end host (e.g., destination 406) behind the last NE on the TCP connection obtains the accumulated latency along the path. The TCP end host determines whether the E2E latency is greater than the accumulated latency when the destination host receives a TCP packet with CAS signaling. If the TCP end host determines that the E2E latency is less than the accumulated latency, the last NE determines that the E2E latency cannot be satisfied. In this case, the TCP end host receives a signal indicating that the TCP connection setup has failed. The TCP end host then sends a TCP capability option (e.g., CAS packet 600) to the source host (e.g., client 403) to inform the source host that the TCP connection setup has failed. For example, the capability options may be set with an “S” indicating that the session setup failed due to latency. If the TCP end host determines that the E2E latency is not less than the accumulated latency, the last NE determines that the E2E latency can be satisfied. In this case, the TCP end host receives a signal indicating that the TCP connection setup has failed. The TCP end host then sends a TCP capability option (e.g., CAS packet 600) to the TCP source host (e.g., client 403) to inform the TCP source host that the TCP connection has been setup.

In an embodiment, the CAS packet 1300, which is a TCP packet that has CAS signaling embedded, is sent from TCP source host to first NE, and then each NE on the path will add its own promised latency to the accumulated latency field 1321. The TCP end host receives the CAS packet 1300 and determines whether the value in the accumulated latency field 1321 is less than the value in the E2E latency field 1318. If the value in the accumulated latency field 1321 is less than the value in the E2E latency field 1318, the session state will be set as established. The TCP end host sends a TCP capability option to the TCP source host to inform the TCP source host that the TCP connection has been setup. If the value in the accumulated latency field 1321 is not less than the value in the E2E latency field 1318, the session state will be set as failed. The TCP end host sends a TCP capability option to the TCP source host to inform the TCP source host that the TCP connection setup has failed.

In the data plane, the routers (such as NE 200, 415, 418, 421, 424) may be configured to forward original IP packets. The QoS guaranteed mechanisms may be realized within the router for the expected IP address and protocol. In an embodiment, the router may be configured to switch packets by pre-allocate flow identifiers (flow IDs) for each IP pipe. In such an embodiment, the QoS guaranteed mechanism may be realized within the router for the expected flow ID. In an embodiment, the router is configured to switch packets by pre-allocated stack of flow IDs. In such an embodiment, the QoS mechanism is realized within the router for the expected flow ID. For example, the flow ID is 32 bits without a size limit. In an embodiment, a compressed flow ID may be used with a size limit. In an embodiment, the router is configured to forward packets by a pre-allocated stack of IP for each hop. In this embodiment, the QoS guaranteed mechanism is realized within the router for the expected IP address and protocol.

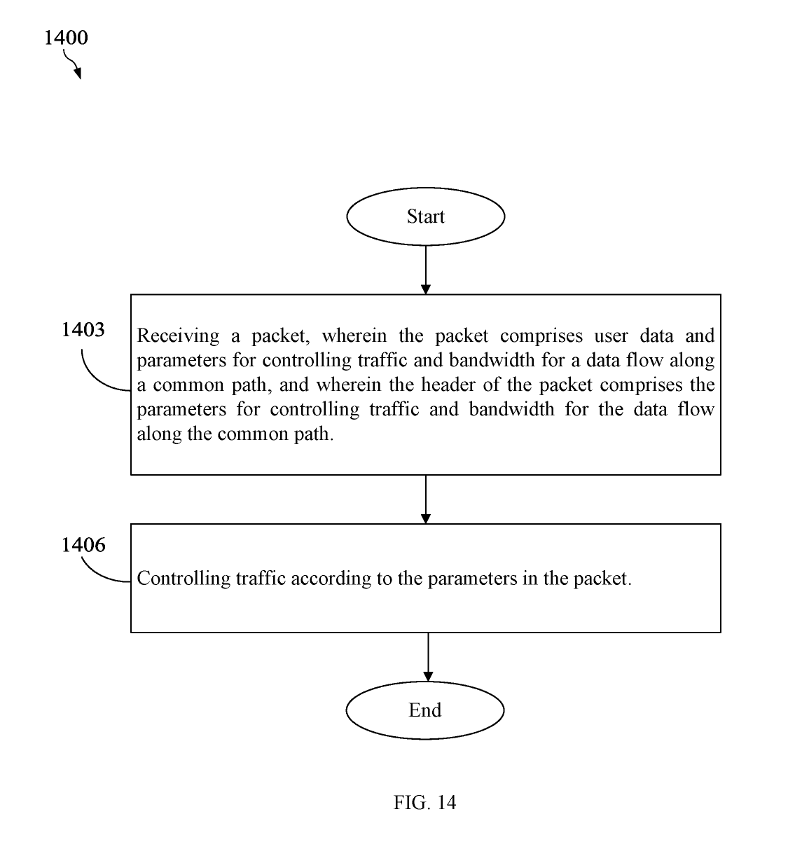

FIG. 14 is a method 1400 of signaling parameters using CAS. The method 1400 may be implemented by a NE (e.g., NE 200, 415, 418, 421, 424) in a network (e.g., the network 100). In step 1403, the NE receives a CAS packet (e.g., CAS packet(s) 500-1300). In an embodiment, the Tx/Rx 220 receives the CAS packet from another router or a source host. In an embodiment, the CAS packet comprises user data and parameters for controlling traffic and bandwidth for a data flow along a common path. In an embodiment, the parameters are carried in a header of the CAS packet. For example, the parameters are carried in optional fields of the header of the CAS packet. For example, the parameters include macro time scale T1, micro time scale T2, average bandwidth B1, burst threshold B2, E2E latency, or accumulated latency (e.g., macro time scale T1 303, micro time scale T2 312, average bandwidth B1 309, burst threshold B2 306). In an embodiment, the parameters may include a maximum bandwidth, a minimum bandwidth (e.g., minimum bandwidth 318 and maximum bandwidth 321), an E2E latency, and/or an accumulated latency. In step 1406, traffic is controlled according to the parameters in the CAS packet. For example, processor 230 is configured to control network traffic according to the parameters in the CAS packet. In an embodiment, the processor 230 may permit the transmission or refuse the transmission of the CAS packet to another NE along the common path.

In an embodiment, the disclosure includes a means for receiving a packet, wherein the packet comprises user data and parameters for controlling traffic and bandwidth for a data flow along a common path, and controlling traffic according to the parameters in the packet.

In an embodiment, the disclosure includes a means for controlling traffic according to parameters in a packet, wherein the packet comprises user data and parameters for controlling traffic and bandwidth for a data flow along a common path, and transmitting the packet toward a second NE according to the parameters in the packet.

The above described CAS for QoS control mechanisms provide numerous benefits. For example, control data can be sent along the same path in the same way that user data is sent. In addition, CAS may bring a fundamental change to the Internet because CAS changes the current Statistical Multiplexing (SM) based internet to SM and Time Division Multiplexing (TDM) based internet. Such a change has a big impact to networks and applications. CAS may also fundamentally improve transport congestion control in a network. For example, using CAS, throughput is no longer limited by the problems that traditional TCP and other optimization technologies encounter. CAS also changes the functioning of applications that use the network because QoS can be controlled by the application directly. Further, CAS may improve features of applications such that applications may use the network more efficiently.

Service providers (SPs) and content providers (CPs) may provide high value-added services with more granularity and differentiations using CAS for QoS control. New billing models may be developed for both SPs and CPs. For example, the SP can charge the client directly based on the QoS path bandwidth and time. In one embodiment, the charge may be based on the session, such as a 4K video session, an 8K video session, or a VR session. In one embodiment, the charge may be based on total bandwidth and/or time. CPs can provide services to the client with different speeds based on the quality of the stream, resolution of the video stream, and/or guaranteed quality of the stream.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of providing high throughput and low latency Internet protocol (IP) transport implemented by a router in a network, comprising:
receiving, by the router, a packet, wherein the packet comprises user data and parameters for controlling traffic and bandwidth for a data flow along a common path, and wherein the header of the packet comprises the parameters for controlling traffic and bandwidth for the data flow along the common path; and
controlling, by the router, traffic according to the parameters in the packet.

2. The method of claim 1, wherein the packet is received from a source host.

3. The method of claim 1, wherein the packet is received from a second network element.

4. The method of claim 1, wherein the parameters indicate a version of Transmission Control Protocol (TCP) channel associated signaling (CAS) used and a state of a session setup between a client and a server.

5. The method claim 1, wherein the packet comprises control data and the user data, wherein the control data comprises the parameters, and wherein the control data and the user data comprise a common IP protocol number, source address, destination address, source port number, and destination port number.

6. The method claim 1, wherein the packet uses an extension Transmission Control Protocol (TCP).

7. The method of claim 1, wherein the packet uses an extension of User Datagram Protocol (UDP).

8. A router in a network, comprising:
a receiver configured to receive a packet, wherein the packet comprises user data and parameters for controlling traffic and bandwidth for a data flow along a common path, and wherein the header of the packet comprises the parameters for controlling traffic and bandwidth for the data flow along the common path; and
a processor operably coupled to the receiver and configured to control traffic according to the parameters in the packet.

9. The router of claim 8, wherein the packet comprises an indicator that identifies whether the packet comprises the parameters for controlling traffic and bandwidth.

10. The router of claim 8, wherein the parameters comprise at least one of an average bandwidth or a macro time interval.

11. The router of claim 8, wherein the parameters comprise at least one of a burst threshold or a micro time interval.

12. The router of claim 8, wherein the parameters comprise at least one of a minimum bandwidth or a maximum bandwidth.

13. The router of claim 8, wherein the packet comprises a field that indicates the values that are carried in the parameters.

14. The router of claim 8, wherein the parameters comprise at least one of an end-to-end (E2E) latency or an accumulated latency.

15. A router in a network, comprising:
a processor configured to control traffic according to parameters in a packet, wherein the packet comprises user data and parameters for controlling traffic and bandwidth for a data flow along a common path, and wherein the header of the packet comprises the parameters for controlling traffic and bandwidth for the data flow along the common path; and
a transmitter operably coupled to the processor and configured to transmit the packet toward a first router in the network in the common path according to the parameters in the packet.

16. The router of claim 15, wherein the packet comprises an indicator that identifies whether the packet comprises the parameters for controlling traffic and bandwidth.

17. The router of claim 15, wherein the parameters comprise at least one of an average bandwidth or a macro time interval.

18. The router of claim 15, wherein the parameters comprise at least one of a burst threshold or a micro time interval.

19. The router of claim 15, wherein the parameters comprise at least one of a minimum bandwidth or a maximum bandwidth.

20. The router of claim 15, wherein the parameters comprise at least one of an end-to-end (E2E) latency or an accumulated latency.
